(19) United States
(12) Patent Application Publication
(10) Pub. No.: US 2021/0406105 A1
(43) Pub. Date: Dec. 30, 2021

(54) METHODS AND APPARATUS FOR IMPROVED FAILURE MODE AND EFFECTS ANALYSIS

(71) Applicant: Omnex Systems, LLC, Ann Arbor, MI (US)

(72) Inventors: Chandran Kymal, Ann Arbor, MI (US); Gregory Francis Gruska, Farmington Hills, MI (US)

(21) Appl. No.: 16/913,759

(22) Filed: Jun. 26, 2020

(51) Int. Cl. G06F 11/07

(52) U.S. Cl. CPC G06F 11/079; G06F 11/0772; G06F 11/0787; G06F 11/0793

(57) ABSTRACT

A processor generates a first allocation matrix and accesses a representation of relationships between individual system elements, representing lower-level system elements to be considered at a current-level of design of a product, with each other. The processor creates an element entry in the first allocation matrix for at least a subset of the individual system elements and creates an element entry in the first allocation matrix for one or more directional relationships between the individual system elements as indicated in the representation. The processor creates function and requirements entries in the first allocation matrix based on pre-existing requirements for the product applicable to the current-level of design and generates additional function and requirements, as well as creates corresponding entries in the first allocation matrix, based on current-level architectural requirements, including at least functions and requirements for one or more of the directional relationships indicated in the representation.

### TECHNICAL FIELD

The illustrative embodiments generally relate to methods and apparatus for improved failure mode and effects analysis.

### BACKGROUND

Failure mode and effects analysis (FMEA) is an analysis that allows a designer/manufacturer (or a designer/manufacturer of a sub-component), to perform an analysis that identifies possible failures of the product or sub-product, as well as any possible causes for a failure or effects from a failure. This can lead to improvements in the manufacturing of the product and its components, in a pro-active attempt to mitigate as many possible failure conditions as possible, with an ultimate goal of producing a product that is highly likely to function as intended. When the product is something incredibly complex, such as an automobile system, that has many parts supplied by many different parties, this sort of analysis can help ensure that possible failures within subcomponents do not lead to overall failure of the system to function as intended.

Failure cause often takes the form of a down-stream analysis, whereby a designer/manufacturer of, for example, a component, considers the elements that go into the component (sub-component, sub-sub-component) for failures in the component that could be caused by those respective elements. Failure effects may have upstream implications—for example, a failure of an airbag deployment system due to a faulty wiring system may have the upstream effect of “no airbag deployed” on the overall airbag system and the current-level effect of “non-functioning of deployment mechanism.” A cause might be, for example, “faulty electrical connection occurring over time to do vehicle vibration” in an electronic control unit that signals the deployment mechanism to fire.

FMEA analysis may be applied to products, processes or services that may include a set of design requirements. These requirements can then be considered when determining what potential failures might result that would ultimately cause a requirement not to be met. These are often known as failure modes, which themselves can have impact on the present level of component and upstream levels as noted above. Identification of failure modes can lead to identification of causes, which are the downstream (sub-element) causes that could result in the identified failure mode.

Once causes are identified, mitigation steps can be taken to mitigate those causes, including improving some aspect of a sub-component to mitigate or negate the likelihood of a cause occurring or creating a redundancy that will also serve to diminish the likelihood of the failure actually occurring. If the cause of a failure does not occur, then the failure does not occur, and thus the overall system does not fail as a direct result of that cause. Even if certain failures cannot be perfectly cured, a massively low likelihood of occurrence based on re-engineering and design may be sufficient in many instances. FMEA can help identify such failures, causes, effects and opportunities to improve the product.

### SUMMARY

In a first illustrative embodiment, a system includes a processor configured to generate a first allocation matrix and access a representation of relationships between individual system elements, representing lower-level system elements to be considered at a current-level of design of a product, with each other. The processor is further configured to create an element entry in the first allocation matrix for at least a subset of the individual system elements. Also, the processor is configured to create an element entry in the first allocation matrix for one or more directional relationships between the individual system elements as indicated in the representation. Further, the processor is configured to create function and requirements entries in the first allocation matrix based on pre-existing requirements for the product applicable to the current-level of design and generate additional function and requirements, and create corresponding entries in the first allocation matrix, based on current-level architectural requirements, including at least functions and requirements for one or more of the directional relationships indicated in the representation. Additionally, the processor is configured to provide the first allocation matrix representing possible, selectable correlations between the element and relationship entries with requirements.

In a second illustrative embodiment, a system includes a processor configured to generate a current-level failure mode and effects analysis (FMEA) for a current-level system represented by an allocation matrix accessible by the processor. The processor is further configured to determine, based on the allocation matrix, one or more failure modes based on requirements included in the allocation matrix. The processor is also configured to include the determined requirements in the FMEA and determine, based on the allocation matrix designating correlation between a given requirement, for which a given failure mode was determined, and one or more system elements, a possible cause of the given failure mode as the correlated system element. The processor is additionally configured to include the determined possible cause as a possible cause for the given failure mode in the FMEA and repeat the determination of possible causes and inclusion of possible causes until the failure modes determined for the FMEA all have corresponding causes, as indicated by the allocation matrix, associated therewith in the FMEA.

In a third illustrative embodiment, a non-transitory storage medium stores instructions that, when executed by a processor, cause the processor to perform a method including generating a current-level failure mode and effects analysis (FMEA) for a current-level system represented by an allocation matrix accessible by the processor. The method further includes determining, based on the allocation matrix, one or more failure modes based on requirements included in the allocation matrix. Also, the method includes including the determined requirements in the FMEA and determining, based on the allocation matrix designating correlation between a given requirement, for which a given failure mode was determined, and one or more system elements, a possible cause of the given failure mode as the correlated system element. The method additionally includes including the determined possible cause as a single point possible cause for the given failure mode in the FMEA and repeating the determination of possible causes and inclusion of possible causes until the failure modes determined for the FMEA all have corresponding causes, as indicated by the allocation matrix, associated therewith in the FMEA.

### BRIEF DESCRIPTION OF THE DRAWINGS

FIG. 1 shows an illustrative example of a process for block diagram creation from a design data contained in a preliminary document;

FIG. 2 shows an illustrative example of the design data;

FIG. 3 shows an illustrative example of a block diagram automatically generated from the design data;

FIG. 4 shows an illustrative process for automatically generating an allocation matrix based on the design data;

FIG. 5 shows an illustrative example of an allocation matrix;

FIG. 6 shows an illustrative example of a recursive process for creating allocation matrices from an upstream allocation matrix

FIG. 7 shows an illustrative example of a process for generating a design FMEA (DFMEA) from a set of allocation matrices;

FIG. 8 shows an illustrative example of a process for generating a Fault Tree Analysis (FTA) from a DFMEA; and

FIG. 9 shows an example of a FTA automatically generated from an FMEA.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Various of the embodiments described herein discuss processes that could be executed by a processor reconfigured as a special purpose processor for the purpose of performing the algorithm, portions thereof, or a similar algorithm to that described with respect to a given embodiment and/or example. It is appreciated that such processors can reside locally or on a cloud-side system or include combinations of processors functioning together. Moreover, such processors are contemplated to have access to and be in communication with various memories also in the same location as the processor or remote from the processor. Memories includes all reasonable type of computer-readable storage media such as, but not limited to, hard disk drives, flash drives, cloud-based storage, etc. These at least include reasonable non-transitory memories storing algorithms and/or data, in whole or in part, usable to enact the illustrative embodiments and the like.

When designing a product that has many groups responsible for different levels of manufacture (e.g., main system, subsystem, sub-subsystem, components/hardware/software, etc.), FMEA may be performed for the entire scope of the architecture. While the illustrative embodiments are described with respect to a product, it is appreciated that similar concepts can be applied to processes or services undergoing FMEA analysis as would be understood by a skilled artisan. Accordingly, descriptions of embodiments relating to products are not necessarily limited to application in the product-sense, from the perspective of FMEA analysis.

As an illustrative example, assume that a Product A has components A1 and A2, which each have sub-components A1a, A1b, and A2a, A2b, respectively. Each subcomponent has two further sub-sub-components (or hardware/software) A1ai, A1aii, A1bi, A1bii, A2ai, A2aii, A2bi, A2bii. Even with this very oversimplified description, it is apparent that a significant amount of opportunity for failure and cause of failure may exist. For further description, the example will assume that A is a Car, A1 is an Aigbag system, A1a is an airbag, and A1ai is an ECU. Again, this is for example purposes only and is not intended to limit the invention in any manner, but rather to allow for examples using understood products.

One existing issue with existing FMEA approaches is that failure causes are linked to lower level elements. That is, for example, a failure in A1b would be considered to be caused by A1bi or A1bii, and a failure in A1 would be considered to be caused by any of the seven components or sub-components rolling up to A1.

There are three different aspects of failures analyzed in such an FMEA: failure effect (FE)—the consequences of a failure; failure mode (FM)—the manner in which an item could fail to meet or deliver the intended function; and failure cause (FC)—an indication of why a failure mode could occur. Each of these would actually be an FM at different levels—e.g., a FC at a lower level is the FM of that level, and a FE at a next lower level.

Using the Car/Airbag example, a requirement of a car might be that the car provide safe transportation. A failure mode would be that the car does not provide safe transportation. An airbag system may be required to protect passengers during a collision, and a failure mode may be that the system is unable to provide passenger safety during a collision. The airbag may be required to deploy on demand in a collision, and a failure would be non-deployment on demand. Finally, the ECU may be required to activate the airbag during a collision, and a failure mode may be non-activation.

In this example, the cause of the failure at the higher level is a down-stream cause. That is, failure to provide safe transportation is caused by failure to protect during collision, which in turn is caused by failure to deploy on demand, which in turn is caused by failure to activate the airbag during collision. These are, of course, not the only possibilities in a fully working airbag system/vehicle design, but are merely simplified for the sake of explanation.

One aspect of the illustrative embodiments describes an improved approach to FMEA, whereby consideration of a cause at the focus level is also contemplated. For example, if the focus level is the airbag system level, instead of just contemplating airbag failure to deploy on demand and non-activation (the sub and sub-sub levels) as causes, it is beneficial to contemplate the present architectural requirements and design of the airbag system as well. Additionally, historical FMEA has contemplated single-point faults as the causes of failure modes. This overlooks the possibility that multi-point faults (multiple causes simultaneously) can cause a failure that would not be cause by either cause occurring alone.

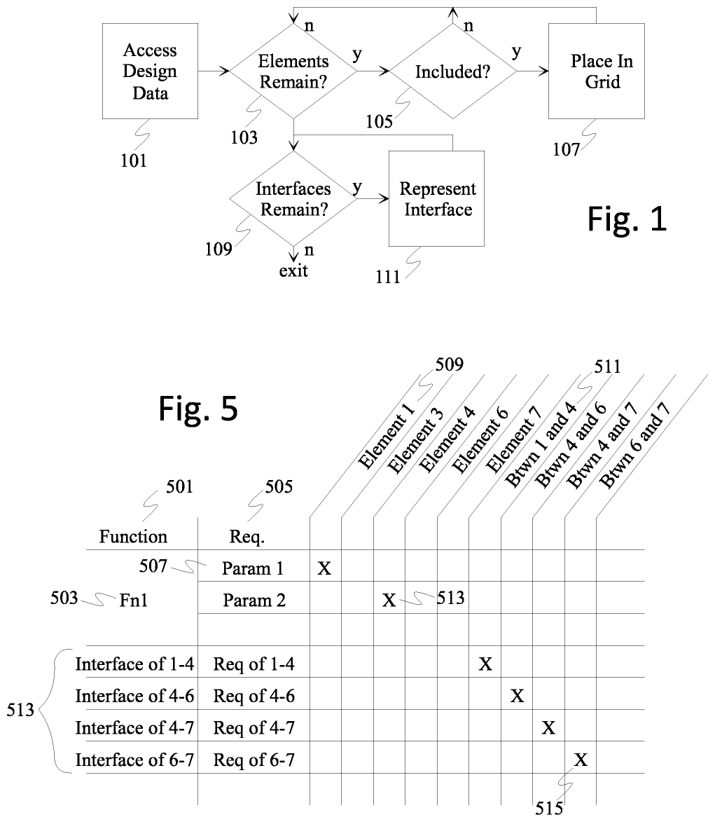

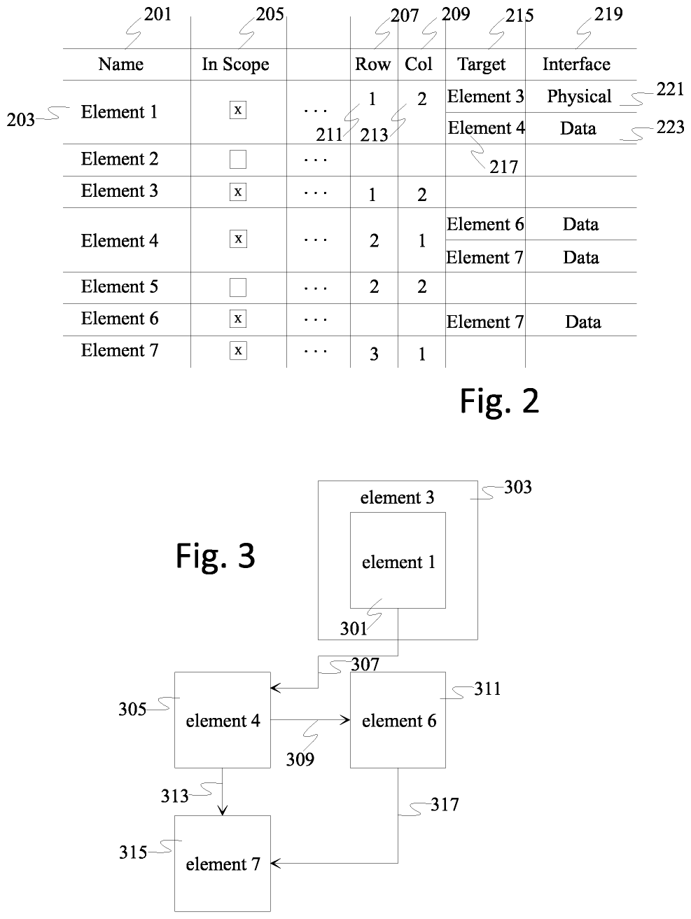

FIG. 1 shows an illustrative example of a process for block diagram creation from a system element and interrelationship document, an example of which is shown in FIG. 2 and described in conjunction with FIG. 1.

In this example, the process will access the design data included in preliminary document at 101. This information, as shown with respect to FIG. 2, defines, for example, without limitation, system elements 201, interface relationships 219 between those elements and an element 215 that is a target of another element in an interrelationship. This data may be embodied in a plurality of varied data sets and the reference to a preliminary document may also include digital representations of a document in various formats. The example shown in FIG. 2 is a representation of the relevant information used for illustrative purposes and is not necessarily the limit of the design data or what would be included in a preliminary document, or digital representation thereof, use to generate a block diagram and/or an allocation matrix.

The document may also show what elements are in scope 205 for a given analysis. For example, the larger document may contain a listing of elements that relate to a variety of systems or subsystems, but only some of those elements may be in scope for a given design and analysis. Example elements are shown as element 1 203, element 2, etc. In this example, the scope box 205 is checked or not checked to define whether an element is in scope, and a row 207 and column 209 designation define where the element should appear in a block diagram. The block diagram can be thought of as a grid, in this example represented by a 3×3 grid. Each row 207 and column 209 designation can determine where in the 3×3 grid an element is placed.

The type of interface may define the nature of the interface between the current element and the target element. For example, a physical interface may be a physical interaction between two elements. So, for example, the physical relationship between element 1 and element 3 defines a physical interface between elements 1 and 3. Another type of interface is data 223, and the data relationship between element 1 and element 4, with element 4 as the target 217, results in an arrow flowing from element 1 to element 4 in the block diagram. Different types of arrows or other indicators can be used to distinguish between various types of interfaces as identified for various elements in the preliminary document.

Interface definitions can define any reasonable inter-relationship between elements as desired, and the target specification can define what sort of representation is to be created based on a rule associated with the interface type and responsive to a target designation.

The illustrative process contemplates a given element at 103 and, if the element is in scope at 105, the process includes the element in the block diagram at the appropriate location at 107. This can continue until all in-scope elements are placed in their proper positions in the block diagram.

Next, in this example, the process considers whether any elements (or any element in a subset of data only representing those in scope elements already included in the diagram) have an interface for which a designation has not been drawn at 109. For example, the element 1 205 has both a physical relationship with element 3, which defines a physical relationship with element 3 that the process will represent at 111. Element 1 also has a data relationship with a target of element 4, which would cause the process to draw an arrow from element 1 to element 4 at 111. This process repeats until no interfaces for in scope elements remain at 109.

In still further embodiments, the preliminary document may include interrelationships between elements whereby one element is contained within another element for the purpose of the block diagram representation. This can be a multi-level relationship whereby, for example, block 3 is inside block 2 is inside block 1. This can also represent an opportunity to identify when another block diagram (e.g., for block 2 including block 3 that is currently inside block 1) may need to be generated. For example, on the basis of a system element being within another system element (the interior system representing, for example, a sub-system), the process may determine that at least one additional allocation matrix is required for the system containing the sub-system.

A single or multiple preliminary documents may be used to generate multiple matrices. For example, in one instance, when a single document is used, in scope designations may be changed depending on what level of system and one or more sub-systems, all represented in the document, is presently at a current consideration level for allocation matrix generation.

The result of this process is a block diagram, an example of which is shown in FIG. 3. This example diagram is based on the system element and interrelationship document shown in FIG. 2. This diagram shows element 1 301 in row 1 col 2 and element 3 placed in col 1 row 1. A dashed arrow from element 1 to 3 represents the physical relationship between elements 1 and 3. The nature of the designation, such as an arrow, may be based on a type of interface designated in the preliminary document. The relationship defined by the interface, or other relationships, may also include a directionality component that may be reflected in the representation chose to represent the relationship.

The diagram further shows the data relationship 307 defined with respect to element 1 301 having element 4 305 as the target. Element 4 305 is placed in row 2 col 1 as defined for element 4 305 in the document. Since element 4 305 has data relationships with element 6 311 and element 7 315 as targets, those relationships are respectively shown by arrows 309 and 313. Finally, the data relationship between element 6 311 and element 7 315 as a target is also shown by arrow 317.

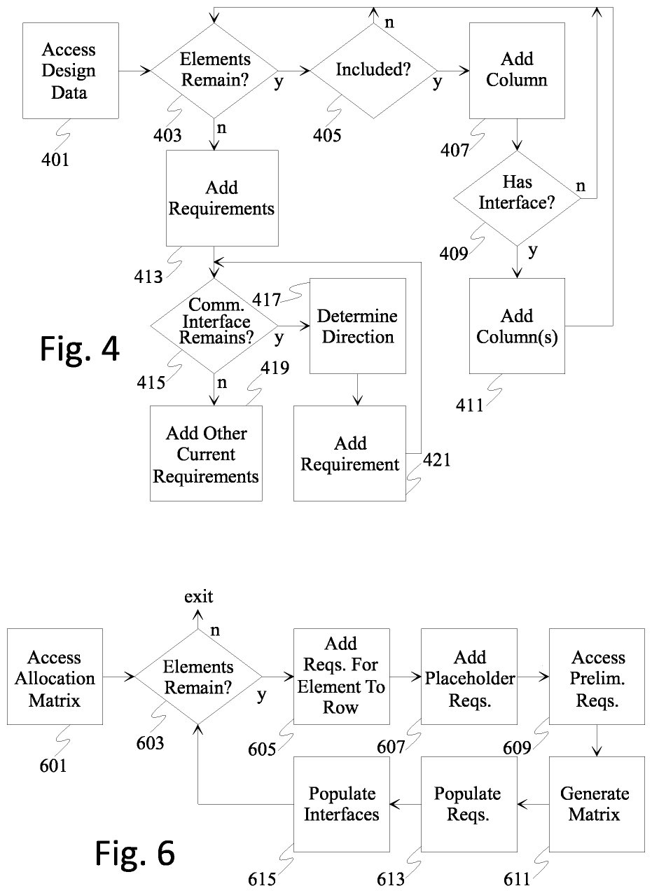

Using the block diagram and/or any underlying meta-data represented by the system element and interrelationship document or a subset of that document including only in scope items, the process shown as an example in FIG. 4 can generate an allocation matrix.

The allocation matrix represents all the functional elements of a given design for consideration in an FMEA, as well as the functional requirements, which can include customer-requirements and any current-level architectural requirements. By including current-level architectural requirements, a design team is forced to consider possible flaws at the current level. This is a deviation from traditional analysis which simply assigned a correlation between customer level requirements and down-stream components that had to meet those requirements. Such analysis could overlook, for example, interface requirements between two components that might be within the purview of the current design level.

For example, a supplier or other team may be required to design an front crash sensor that meets a collision speed detection requirement and an airbag that meets a collision speed activation requirement. Both of these requirements may be from a customer who will purchase the airbag system, as a part of requirement for a function that an airbag will deploy on-demand. If these were the only requirements that were considered, then an engineer would conclude that an airbag system was not likely to fail if these requirements were met and the likelihood of failure of either was zero or sufficiently low.

At a current design level, however, the team may be responsible for providing the communication interface between the frontal crash sensor and the airbag (again, a simplification of the system for illustrative purposes only). So, in that instance, if there was a communication failure, such as, but not limited to, data loss, failed decryption, an electrical short, etc., the message would never reach the airbag. If the chance of such an occurrence was 1%, then even if the frontal crash sensor were perfect and the airbag were perfect for their intended purposes, the overall system would fail 1% of the time.

Under the old methodologies of requirement derivation and cause consideration, design teams were not contemplating current-level architectural requirements along with downstream requirements as defined causes for failure modes at the present level. The present examples provide illustrative embodiments that demonstrate how such a paradigm shift can improve the overall success of the analysis, resulting in better, safer products with fewer failures, as well as improve the ability of the analysis to actually identify all possible failures and causes, and provide testing for the additional possible causes that were not previously considered.

An example of such an allocation matrix is shown with respect to FIG. 5 and described in conjunction with FIG. 4, which shows an illustrative example of a process for generating an allocation matrix from the block diagram and/or underlying metadata. In this example, the process accesses the design data at 401, which is usable to identify in scope elements, interfaces and interface targets. While elements remain at 403, the process determines if a given element is included (in scope) at 405.

If the element is in scope, then the process at 407 includes the element as a column label 509. Additionally, in this example, the process ensures the design team consider the present interfaces, by also assigning at 411 a column 511 label for each interface designating the directionality and origin/destination identified at 409. When the process has worked its way through all of the elements identified in the block diagram, it will also have columns for all interfaces represented in the block diagram. Of course, if certain interfaces are not relevant for requirement/cause consideration, the process can omit those on a by-type basis or based on other parameters defined for omission.

The process further at 413 adds row labels for each function 501 and requirements of the function 505. For example, a function may be “airbag deploys on demand,” and several requirements may be defined for a collision above a certain speed, a collision below a certain speed, etc. This requirement may have come from the customer and may be accessible from a record of customer functions and requirements. Traditional function/requirement addition would have terminated at this point for traditional purposes of developing an FMEA.

In this example, however, the function addition continues for each of the interfaces at 415, or a subset of interfaces defined as having relevance for present consideration based on characteristics of interfaces (e.g. type). For each data interface, for example, the process determines a directionality at 417 and adds a requirement at 419. The function, in this example, is named to identify the data flow and the fact it is an interface, e.g., without limitation, Interface Function of element 1-element 4, where element 1 is the origin and element 4 is the target. This may be further listed as a requirement for a present level FMEA, which then includes consideration of all of the interfaces, or a subset of the interfaces, as part of the FMEA, ensuring that current-level design and analysis teams do not overlook possible causes within the scope of their own design level, and instead continue to look to downstream components for causation. Examples of such functions and requirements are shown as elements 513.

While the example is shown with respect to data interfaces, the process can also add other interfaces and relationships as column headers at 421, to ensure all relevant interfaces are considered when developing a current level design FMEA.

The allocation matrix also includes a designation of relevance, which may be referred to as an allocation 513 that interrelates a requirement (and thus a function) that is a row label to a given element that is a column label. The allocation, for example, identifies that a function at a lower level that generates the function at a higher level. This allocation at the higher level identifies which lower level elements provide the capability to produce the higher level function.

This allows for later recursive population of those requirements when a design document and FMEA is performed for a sub-component, the correlations between requirements and elements can be used to automatically assign those requirements to a given element's own set of requirements.

In this example, a further designation exists interrelating the current-level architecture requirements to the current interfaces 515. This allows for those requirements to be considered in a current level FMEA.

FIG. 6 shows an illustrative example of a recursive process for creating allocation matrices from an upstream allocation matrix. Some or all elements in the upstream matrix may require their own allocation matrix, and may further have their own preliminary document associated therewith or may be included in a preliminary document that allows them to be placed in scope for a given lower level allocation matrix for the element.

Using the upstream allocation matrix at 601, the process will generate downstream allocation matrices for any appropriate elements. Until no elements remain at 603 for which matrices are required, the process will create a list of requirements at 605 for an element based on the current allocation matrix which is an upstream matrix for the given element. This can include, for example, adding in any requirements that have a correlation with a given element defined in the allocation matrix.

If the element is an interface element representing current-level elements to be considered, correlation of the interface element to an interface requirement results in generation of placeholder requirements for all elements that are part of the interface. Those placeholder requirements are added to the list of requirements for the interface allocation matrix for a given interface at 607.

The process can then access a set of preliminary documents to generate the allocation matrix column headers at 611, and can fill in the requirements inherited from the upstream matrix at 613, as well as any placeholder requirements inherited from the upstream matrix at 615. This process can continue for all elements in the current (upstream with regards to the elements) matrix and then be repeated again for all elements in the newly generated downstream allocation matrices, recursively generating sets of allocation matrices for all sub-components, sub-sub-components, etc., down to the individual components that have no sub-parts needing consideration.

In one illustrative example, allocation matrices may continue to be generated until a level where failure rate is known. Additionally or alternatively, matrices may continue to be generated until there exist sufficient requirements for provision to designers and/or suppliers.

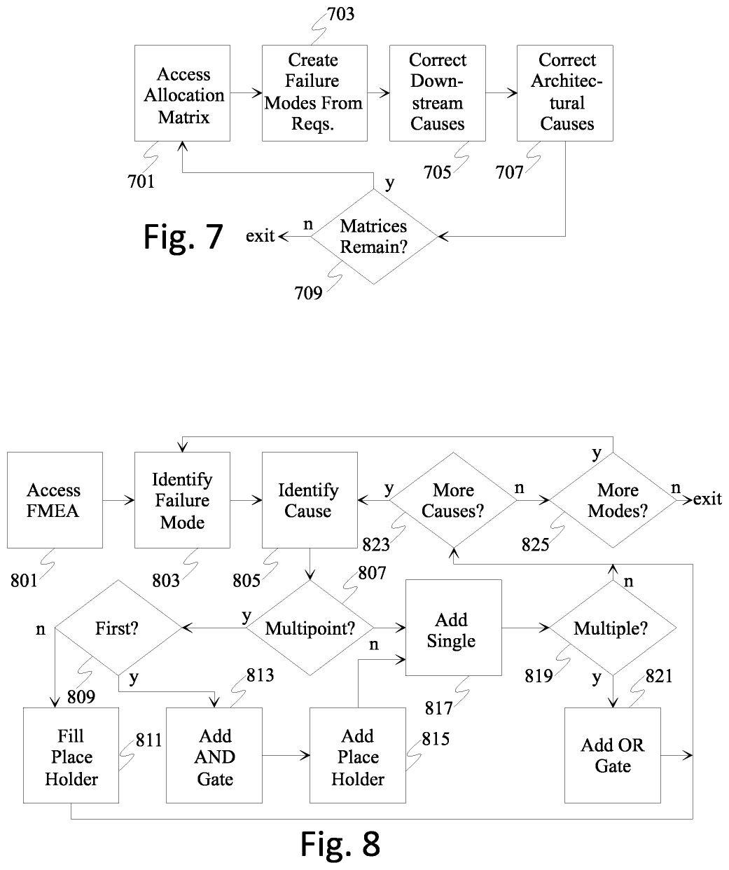

FIG. 7 shows an illustrative example of a process for generating a design FMEA (DFMEA) from a set of allocation matrices. In this process, the input includes a set of allocation matrices at 701. Each allocation matrix has a set of requirements that can be used to create failure modes for those requirements at 703.

The process can then use the interrelationships between the requirements and the elements of a given matrix to create a set of possible causes for a failure mode for a given requirement at 705. Within design of a complex system, multiple FMEAs may be generated for multiple levels. At a given level the failure mode of a requirement may be caused by the failure mode of a downstream element or requirement, and thus a complete analysis may require a plurality of FMEAs. The illustrative embodiments are capable of automatically generating the family of FMEAs required for a current level of design or a whole system design.

Because the allocation matrix also represents current level architectural requirements, failure modes and causes can also be assigned to the architectural requirements of the current level at 707. This allows the DFMEA document to reflect possible interface failures at the current level, so using the example presented previously, the failure modes would include failure modes (e.g., does not detect collision at speed X) with a cause as a failure of the frontal crash sensor, but also may include a failure more for the interface between the sensor and the airbag (e.g., does not communicate) with possible causes as data corruption or electrical short. Without contemplating this additional failure mode and cause set as part of the FMEA, a cross-functional team would not necessarily understand why a perfect crash sensor and a perfect airbag were still failing 1% of the time because the communication failed 1% of the time.

The process continues for any allocation matrices remaining at 709 until all failure modes and causes have been added to a given DFMEA for each level. Causes of failure modes at an upstream level can be represented by occurrences of failure modes at a downstream level. That is the traditional analysis, but with the inclusion of architecture requirements at the current level, causes may also be represented by failure modes at the current level, if the failure mode corresponds to an architectural requirement of the current level, for example.

FIG. 8 shows an illustrative example of a process for generating a Fault Tree Analysis (FTA) from a DFMEA. This illustrative example allows for creation of an FTA from the FMEA, which has traditionally been represented as sequential layers of gates usable to calculate the net probability of failure based on a combination of probabilities of root causes. In such a tree, where either cause that can result in a failure mode occurs, the failure mode result is representable by an OR gate, which is true if either cause occurs, meaning the failure mode occurred. A single FMEA with multiple safety goals can be used to provide multiple FTAs, one for each safety goal.

It was difficult to correlate FTAs and FMEAs in the past because FMEAs did not historically consider multi-point failures. With the innovative capability to provide for multi-point failures in the FMEA as described in conjunction with the illustrative embodiments, the embodiments provide FMEAs that allow for generation of the FTA using the FMEA, and ensuring the FTA accommodates the multi-point causes now reflected in the FMEA. This is an improvement over existing systems in which an FTA could not be generated from an FMEA, or vice versa, because at least of the lack of correlation.

In addition to single-point causes, the illustrative embodiments contemplate multi-point causes as part of the FMEA. These may be especially important in digital systems and may be overlooked in traditional OR style single-point analysis. A multi-point cause can be represented in the FMEA and is represented in the FTA as AND gate. That is, unless both causes occur (or both sub-sub-systems fail), the overall failure mode of the AND gate will not occur.

So, for example, in digital systems, bad data results from a single system may not cause an issue, but the correspondence of two particular sets of bad data can cause a system fault that would not occur under the individual instance of a single data error. In a mechanical system, a backup system may be provided that exists for the sake of redundancy in safety-critical systems, but if both the primary and backup system fail, then a failure mode occurs as a result of both mechanical failures. However rare, if these multi-point occurrences may be frequent enough to warrant consideration in critical systems, the illustrative embodiments provide for their inclusion and handling in FTA generation. Moreover, the ability to contemplate and include such factors represents a marked improvement over prior FMEA and FTA systems that did not contemplate such multi-point occurrences.

In the illustrative example shown in FIG. 8, the process accesses the FMEA at 801. It is also possible to develop the FMEA automatically from an FTA, if the FTA is developed first. In this example, the process identifies a failure mode at 803, which as previously noted was automatically added to the FMEA from the allocation matrix. The failure mode has one or more causes included therewith, and the process identifies one or more causes for the failure mode from the FMEA at 807.

When a given cause is a multipoint cause (identified in the FMEA as such) at 807, the process determines if that is the first of the multi-points at 809. If the cause is first, the process will add an AND gate representing the failure mode resulting from the multipoint cause at 813 and add placeholders for the additional multi-points at 815. Additional and subsequent multi-point causes will be added to the AND gate failure mode at 811. It is possible to simply create the AND gate and add all the causes, this illustrative process simply demonstrates a cause-by-cause handling process and is not intended to be limiting in any manner.

It is also possible that the failure mode for the multi-point cause is itself a cause, in which case the process also creates a single-point cause (the result of the multi-point AND consideration) at 817. This is similar to what would occur if there were another single point cause identified for a given failure mode. If there are multiple single-point causes at 819 (where any one cause would cause failure, irrespective of the other cause states), the process will add an OR gate at 821 or append the cause to an already existing OR gate created for a different single point cause for the same failure mode.

If there are more single-point causes for the failure mode at 823, the process will identify a next-cause at 805 and repeat the analysis. It is appreciated that this illustrative example is just one way to convert an FMEA into an FTA, and that the order of operations specified herein is for illustrative purposes only, as is the consideration of when the process moves to a next level. If there are no more causes remaining for a given failure mode, the process determines if additional failure modes remain at 825 and moves to a next mode at 803 if there are additional modes.

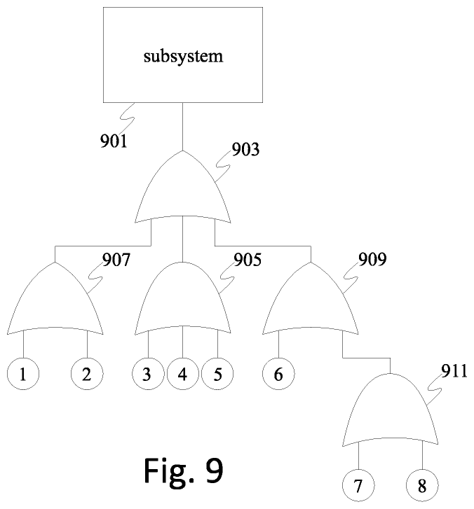

FIG. 9 shows an example of a FTA with a plurality of AND and OR gates. The process discussed in FIG. 8 may start with an FMEA for a subsystem 901. The subsystem being analyzed may require multiple levels of FMEA in order to determine the underlying failure modes represented by 1-8 at the bottom of the tree.

As the process moves through the FMEA failure modes and causes, it will observe that the subsystem will fail if any one of 3 single possible causes 905, 907, 909 occurs. Thus, three causes are appended to the OR gate representing failure mode 903. As each of these causes is a single point cause, the OR gate is chosen.

The first possible cause for a subsystem failure is also derived from two single point failure modes 1 and 2. Again, either cause can result in a failure that propagates up to the subsystem, and so an OR gate represents the conjunction of these two failure modes. The next possible subsystem failure cause results from a three failure mode multi-point cause, with failure modes 3, 4 and 5. In this instance, the failure of the subsystem only occurs when all three failure modes 3, 4 and 5 occur, and so an AND gate is chosen to represent this combination.

Moving next to possible cause 909, there is an instance where the subsystem failure occurs when either failure mode 6 occurs OR failure modes 7 AND 8 occur. Since there are still two effective “single point” possible causes that can result in subsystem failure here, even though one is the result of a multi-point cause, an OR gate is chosen initially. Finally, an AND gate is added for failure modes 7 and 8, since both must occur for the possible cause 911 resulting from 7 and 8 failing to occur. This is then which is then one of the two possible single point causes for propagation to subsystem failure.

Different considerations were made at various levels in the FTA to be able to conclude the overall likelihood of failure of the subsystem. Because the FMEA includes multi-point causes, unlike in existing models, the process can actually use the FMEA to generate the useful FTA that reflects both single point and multi-point causes.

Multipoint identification may be a complex process because there are so many possible combinations of variables. Historical analysis and learning, however, can aid in the identification of multi-point faults. For example, although not limited to products of the same family, when products are of the same family they often share similar components and subsystems. Real-world failure identified by post-facto observation to determine causation can provide for data points usable in future analysis. Accurate identification of multi-point causes in a prior model or parent or child model (in a family of products) can also be stored as historical information.

When generating an FMEA, for example, a process shown can examine all of the systems, sub-systems, and compare those to a database established for either a family or a larger overall database with historical multi-point fault occurrences resulting from known combinations of causes. If causes that have been historically identified as part of multi-point causes exist in the FMEA, the process can look for known paired causes also occurring in the FMEA. If two causes that have been known to result in multi-point failure exist in an FMEA, the process can automatically identify those as a possible multi-point cause and identify a corresponding failure mode for inclusion in the FMEA along with a multi-point cause identifier. This improves the ability of the FMEA generation process by including at least a subset of expected or possible multi-point causes so that those are not subsequently overlooked when developing additional, possible, previously unknown multi-point causes.

It may also be possible to rule out certain multi-point causes on similar grounds, if records of proposed multi-point causes that did not ultimately result in a failure mode were kept. Since the number of possible multi-point causes in a complex system could be very high, the ability of the processes to add or remove certain multi-point causes can greatly streamline the completion of the FMEA.

In one illustrative example, a process could generate a list of possible multi-point faults based on the existing single-point faults, e.g., all existing single-point faults or a subset if appropriate. Then the list can be prioritized based on historical analysis of failures or other appropriate guidelines relating to existing knowledge about the likelihood or unlikelihood of a given multi-point combination.

In still a further example, the illustrative embodiments may provide metrics related to fault analysis, which can include, for example, single point fault metrics, latent point fault metrics and probabilistic metrics for random hardware failures. Because safety-critical systems and products may have certain mandated requirements with regards to metrics such as these, the ability to obtain these metrics for an overall product or even a subsystem is very useful.

If the metrics come back above threshold requirements, which may be known for the product or subsystem for which the metrics are provided, the process is also capable of determining where to place safety mechanisms to reduce the metrics down to threshold levels. By automatically identifying one or more sets of safety-mechanism locations that result in metric compliance, the process provides an improved end-result allowing for a more effective design experience.

A safety mechanism or diagnostic is used to detect faults that can cause a failure and reduce the failure rates. An illustrative process may calculate a failure rate for each single point fault and multi-point fault, for example, and identify which faults require safety mechanisms to meet threshold single-point and multi-point metrics and failure in time metrics.

A single-point fault metric may identify a proportion of all the failure rates that are due to single-point faults, and a design team may have a requirement that this metric be below a threshold. For example, there may be four single-point faults, but they may not contribute equally to the aggregate metric. So, for example, if fault 1 has a 50% contribution (e.g., 50% of single point failure rates result from fault 1), then the net contribution of faults 2, 3 and 4 is necessarily 50%. This makes fault 1 a candidate for reduction if the threshold is 50%, wherein the reductions can constitute, for example, a safety mechanism with regards to fault 1 or a safety mechanism with regards to faults 2, 3 and 4.

The above metrics may be represented, for example a failure mode effects and diagnostics analysis (FMEDA) or diagnostic coverage analysis. The illustrative embodiments provide an opportunity to use such an analysis, through the method described above or the like, in order to automatically identify opportunities for safety-mechanism inclusion to ensure compliance with targeted metrics. These safety mechanisms can be recommended for inclusion in the FMEA, or automatically added to the FMEA at the relevant levels.

The illustrative embodiments not only automatically generate allocation matrices (at multiple levels), corresponding block diagrams, corresponding FMEA and FTAs, but also include improved failure modes represented by current-level architectural requirements, and improved cause identification related to the improved failure modes. The illustrative embodiments provide for improved FTA and FMEA considerations through the inclusion of multi-point analysis and representation as well as utilizing machine learning to better identify likely or unlikely multi-point causes. The ability of the illustrative embodiments to not only provide standardized metrics, but also to address deficiencies in those metrics by automatically suggesting safety mechanism placement improves the ability of engineers to create an end product that is in compliance will all standards or company goals.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
a processor configured to:
generate a first allocation matrix;
access a representation of relationships between individual system elements,
representing lower-level system elements to be considered at a current-level of design of a product, with each other;
create an element entry in the first allocation matrix for at least a subset of the individual system elements;
create an element entry in the first allocation matrix for one or more directional relationships between the individual system elements as indicated in the representation;
create function and requirements entries in the first allocation matrix based on pre-existing requirements for the product applicable to the current-level of design;
generate additional function and requirements, and create corresponding entries in the first allocation matrix, based on current-level architectural requirements, including at least functions and requirements for one or more of the directional relationships indicated in the representation; and
provide the first allocation matrix representing possible, selectable correlations between the element and relationship entries with requirements.

2. The system of claim 1, wherein the representation of relationships between individual system elements includes a block diagram.

3. The system of claim 1, wherein the representation of relationships between individual system elements includes a preliminary document detailing at least individual system elements, a defined interface relationship and directionality of the interface.

4. The system of claim 3, wherein the processor is further configured to:
determine a set of in scope individual system elements based on the preliminary document;
determine placement of the in scope elements within the framework of a block diagram based on placement information included in the preliminary document;
place the in scope elements in the determined placements;
determine directional relationships between the in scope elements based on the preliminary document;
place representations of the directional relationships within the block diagram, the representations representing directionality and having at least one visual characteristic based on a type of the directional relationship determined based on the preliminary document.

5. The system of claim 3, wherein the processor is further configured to:
determine a sub-system relationship between two individual system elements based on the preliminary document, defining a first of at least two individual system elements that is a sub-part of a second of the at least two individual system elements; and
place the first system element within the second system element within the block diagram.

6. The system of claim 5, wherein the processor is further configured to generate a second allocation matrix for at least the second of the at least two individual elements, responsive to the occurrence of the first system element defined as within the second system element; and
accessing a representation of relationships between second individual system elements of a second system represented by the second system element;
create an element entry in the new allocation matrix for at least a subset of the individual second system elements;
create an element entry in the second allocation matrix for one or more directional relationships between the second individual system elements as indicated in the representation;
create function and requirements entries in the second allocation matrix based on pre-existing requirements for the product applicable to a level of design represented by the second system, including at least any requirements correlated to the second system in the first allocation matrix;
generate additional function and requirements, and create corresponding entries in the second allocation matrix, based on architectural requirements for the level of design represented by the second system, including at least functions and requirements for one or more of the directional relationships indicated in the representation of relationships between second individual system elements; and
provide the second allocation matrix representing possible, selectable correlations between the element and relationship entries with requirements.

7. The system of claim 1, wherein the element entry in the first allocation matrix for one or more directional relationships includes directionality of a relationship between at least two system elements.

8. A system comprising:
a processor configured to:
generate a current-level failure mode and effects analysis (FMEA) for a current-level system represented by an allocation matrix accessible by the processor;
determine, based on the allocation matrix, one or more failure modes based on requirements included in the allocation matrix;
include the determined requirements in the FMEA;
determine, based on the allocation matrix designating correlation between a given requirement, for which a given failure mode was determined, and one or more system elements, a possible cause of the given failure mode as the correlated system element;
include the determined possible cause as a possible cause for the given failure mode in the FMEA; and
repeat the determination of possible causes and inclusion of possible causes until the failure modes determined for the FMEA all have corresponding causes, as indicated by the allocation matrix, associated therewith in the FMEA.

9. The system of claim 8, wherein the processor is configured to include the cause as a single-point cause.

10. The system of claim 9, wherein the processor is configured to determine, for at least one failure mode having a plurality of single-point causes, one or more multi-point causes representing combinations of the single-point causes for the at least one single-point cause.

11. The system of claim 10, wherein the processor is configured to sort the one or more multi-point causes based on comparison to historical data indicating historical multi-point cause occurrences, wherein the historical data is correlated to the determined multi-point causes based on historical multi-point causes having the same aggregated single-point bases as individual ones of the determined multi-point causes.

12. The system of claim 10, wherein the processor is further configured to add the determined multi-point causes to the FMEA as possible causes for the at least one failure mode.

13. The system of claim 8, wherein the processor is configured to generate a fault tree analysis (FTA) based on the FMEA, the FMEA including one or more single-point causes associated with one or more failure modes and multi-point causes associated with one or more failure modes.

14. The system of claim 13, wherein the processor is configured to represent the single-point causes as OR gates in the FTA, based on the occurrence of single-point causes in the FMEA, and to represent the multi-point causes as AND gates in the FTA, based on the occurrence of multi-point causes in the FMEA.

15. The system of claim 13, wherein the processor is further configured to obtain a set of metrics based on a failure mode effects and diagnostics analysis (FMEDA) related to the FMEA and to determine one or more safety mechanism inclusions in the FMEA that will result in at least one metric represented by the FMDEA being below a predefined threshold requirement.

16. A non-transitory storage medium storing instructions that, when executed by a processor, cause the processor to perform a method comprising:
generating a current-level failure mode and effects analysis (FMEA) for a current-level system represented by an allocation matrix accessible by the processor;
determining, based on the allocation matrix, one or more failure modes based on requirements included in the allocation matrix;
including the determined requirements in the FMEA;
determining, based on the allocation matrix designating correlation between a given requirement, for which a given failure mode was determined, and one or more system elements, a possible cause of the given failure mode as the correlated system element;
including the determined possible cause as a single point possible cause for the given failure mode in the FMEA; and
repeating the determination of possible causes and inclusion of possible causes until the failure modes determined for the FMEA all have corresponding causes, as indicated by the allocation matrix, associated therewith in the FMEA.

17. The storage medium of claim 16, wherein the method further includes determining, for at least one failure mode having a plurality of single-point causes, one or more multi-point causes representing combinations of the single-point causes for the at least one single-point cause and adding the determined multi-point causes to the FMEA as possible causes for the at least one failure mode.

18. The storage medium of claim 17, wherein the method further includes generating a fault tree analysis (FTA) based on the FMEA, the FMEA including one or more single-point causes associated with one or more failure modes and multi-point causes associated with one or more failure modes.

19. The storage medium of claim 18, wherein the method further includes representing the single-point causes as OR gates in the FTA, based on the occurrence of single-point causes in the FMEA, and to represent the multi-point causes as AND gates in the FTA, based on the occurrence of multi-point causes in the FMEA.

20. The storage medium of claim 16, the method further comprising obtaining a set of metrics based on a failure mode effects and diagnostics analysis (FMEDA) related to the FMEA and determining one or more safety mechanism inclusions in the FMEA that will result in at least one metric represented by the FMDEA being below a predefined threshold requirement on the basis of one or more fault contributions being aggregable to drop the at least one metric below the threshold requirement when the one or more fault contributions are addressed by one or more safety mechanisms.
